(19) United States
(12) Patent Application Publication
(10) Pub. No.: US 2018/0184664 A1
(43) Pub. Date: Jul. 5, 2018

(54) Method to maximize insect mortality by placement of non-ingestible insect attractant in juxtaposition to ingestible insectcide

(71) Applicant: David Lynn Cameron, Port Orange, FL (US)

(72) Inventor: David Lynn Cameron, Port Orange, FL (US)

(21) Appl. No.: 15/530,350

(22) Filed: Jan. 3, 2017

(51) Int. Cl. A01N 59/14; A01N 61/00

(52) U.S. Cl. CPC A01N 59/14; A01N 61/00

(57) ABSTRACT

A method for use of ingestible boric acid as an insect-killing chemical to kill Blatella germanica is disclosed, said boric acid being separate from and juxtaposed to honey made non-ingestible by absorption into wood, the presence of said non-ingestible honey stimulating feeding behavior by said Blatella germanica, which ingest the boric acid as they might ingest a food.

This application comprises the applicant's request for continued examination, and claims the benefit of the Provisional Patent Application Ser. No. 62/387,858 filed on Jan. 6, 2016, by the current applicant.

### BACKGROUND

### Prior Art

The following is representative of the custom blends type of approach to the use of boric acid in an insect-killing bait

### U.S. Patents

| Pat. No. | Issue Date | Patentee |
|---|---|---|
| 4,988,516 | 21 Jan. 1991 | Herring |

### Discussion

Control of insect pests, especially the common cockroach, remains a significant problem in the United States. The use of a bait for control of insects in homes and businesses, and the use of boric acid as an insect-killing chemical, are well known in the prior art. Pure boric acid itself has not, however, been used effectively as a bait in the prior art. Cockroaches may ignore, or in the worst case, even actively avoid pure boric acid when used as directed in the prior art.

Duda Energy (LLC) suggests that pure boric acid can be used against cockroaches by spreading a light coating of the dry powder over areas where the insects are expected to crawl. The use of an attractant is not indicated by Duda Energy. If the cockroaches do crawl through the boric acid, the dry powder coats the body of the insect. Then, it is hoped, the cockroach will ingest a lethal amount of the boric acid in simply cleaning the powder from its body. This strongly distinguishes the current invention from the method of Duda Energy in that non-ingestible honey, being absorbed into wood and being juxtaposed to pure boric acid, stimulates feeding behavior by cockroaches, which then ingest the pure boric acid as they might ingest a food.

Cockroach control as suggested by Wang, et. al., does recommend the use of an attractant, but does not utilize any bait. The insects are attracted and then physically held in place by an adhesive compound. Feeding behavior by the insects is not necessary in this approach to insect control.

Numerous efforts in the prior art to control insects with boric acid involve physically mixing the boric acid with other material expected to be ingested by the insects as food. This is the “custom blends” approach as represented by the method of Herring (U.S. Pat. No. 4,988,516; dtd January 1991). These methods all suffer the disadvantages of being difficult to prepare the needed custom blend and needing periodic replacement of the blend left for insects caused by spoilage of the food component of the bait mixture.

The need for a simple, effective method for cockroach control remains. In the current invention, honey-impregnated squares of wood are prepared in advance. The user of the method need only place a sample of pure boric acid on the square and leave it where cockroaches search for food. The non-ingestible honey in the wood stimulates feeding behavior by the cockroaches, which ingest the boric acid as they might ingest a food.

### SUMMARY

A unique approach to the use of pure boric acid for killing Blatella germanica is disclosed, it having been discovered that when pure boric acid is presented to Blatella germanica on small pieces of honey-impregnated wood, the cockroaches ingest the boric acid as they would ingest a food. The honey, made non-ingestible by said Blatella germanica by absorption into wood, attracts the cockroaches and promotes feeding behavior by them, with pure boric acid being the sole ingestible material immediately available.

### DETAILED DESCRIPTION

Natural honey is applied to one side of an absorbent wooden square, in a first embodiment said wooden square measuring approximately 1.5 in×1.5 in×0.20 in, said honey being allowed to penetrate into said absorbent wooden square. A sample of pure boric acid is placed onto the surface of the square onto which the honey had been applied, in said first embodiment said sample comprising about 0.3 grams of boric acid, and said sample variably covering about one-fifth to one-fourth of said honey-impregnated wooden square. The honey-impregnated wooden square, now holding approximately 0.3 grams of pure boric acid, is placed where cockroaches search for food.

I claim:

1-6. (canceled)

7. A method for killing Blatella germanica comprising the impregnation of wood with honey, the absorption of said honey by said wood rendering said honey non-ingestible by said Blatella germanica, boric acid being placed onto said honey-impregnated wood as an ingestible insect killing compound.
